(19) United States
(12) Patent Application Publication
(10) Pub. No.: US 2015/0302278 A1
(43) Pub. Date: Oct. 22, 2015

(54) IMAGE PROCESSING APPARATUS AND IMAGE PROCESSING METHOD

(71) Applicant: Shinya TANAKA, Tokyo (JP)

(72) Inventor: Shinya TANAKA, Tokyo (JP)

(73) Assignee: RICOH COMPANY, LIMITED, Tokyo (JP)

(21) Appl. No.: 14/686,293

(22) Filed: Apr. 14, 2015

(30) Foreign Application Priority Data
Apr. 16, 2014 (JP) 2014-084972

(51) Int. Cl. G06K 15/02

(52) U.S. Cl. CPC G06K 15/025

(57) ABSTRACT

An image processing apparatus includes a first image processor configured to perform a first image processing not using a setting by a user on image data obtained by scanning a document; a first storage unit configured to store first image data corresponding to the image data on which the first image processing has been performed; a second image processor configured to perform a second image processing using the setting by the user on the first image data; a second storage unit configured to store second image data corresponding to the first image data on which the second image processing has been performed; and a preview image generator configured to generate a preview image based on the second image data, the preview image indicating a predicted result of a print execution.

### CROSS-REFERENCE TO RELATED APPLICATION

The present application claims priority to and incorporates by reference the entire contents of Japanese Patent Application No. 2014-084972 filed in Japan on Apr. 16, 2014.

### BACKGROUND OF THE INVENTION

1. Field of the Invention

The present invention relates to an image processing apparatus and an image processing method.

2. Description of the Related Art

Conventionally, known has been a technique of generating and displaying a preview image which is an image as a predicted result in executing printing by following various kinds of settings by a user (settings for density, scaling, color/black and white, margin adjustment, and the like, for obtaining a target printed material) prior to starting the printing.

For example, Japanese Laid-open Patent Publication No. 2006-003568 discloses a technique of generating and displaying finish prediction information (preview image) based on image data obtained by scanning by a scanner from a document and updating, when an input for setting by a user is received, the finish prediction information based on the received setting and the image data obtained by scanning by the scanner.

However, there is a problem that the technique disclosed in Japanese Laid-open Patent Publication No. 2006-003568 requires re-scanning of the document to generate a preview image following various kinds of settings by the user when image data obtained by executing image processing of various kinds on the image data obtained by scanning by the scanner is stored in a main memory and a preview image is generated from the image data stored in the main memory.

Therefore, there is a need for an image processing apparatus and an image processing method capable of generating a preview image following various kinds of settings by a user without a necessity of scanning a document more than once.

### SUMMARY OF THE INVENTION

It is an object of the present invention to at least partially solve the problems in the conventional technology.

According to an embodiment, there is provided an image processing apparatus that includes a first image processor configured to perform a first image processing not using a setting by a user on image data obtained by scanning a document; a first storage unit configured to store first image data corresponding to the image data on which the first image processing has been performed; a second image processor configured to perform a second image processing using the setting by the user on the first image data; a second storage unit configured to store second image data corresponding to the first image data on which the second image processing has been performed; and a preview image generator configured to generate a preview image based on the second image data, the preview image indicating a predicted result of a print execution.

According to another embodiment, there is provided an image processing method that includes performing a first image processing not using a setting by a user on image data obtained by scanning a document; performing a second image processing using the setting by the user on first image data stored in a first storage unit, the first image data corresponding to the image data on which the first image processing has been performed; and generating a preview image based on second image data stored in a second storage unit, the second image data corresponding to the first image data on which the second image processing has been performed, the preview image indicating a predicted result of a print execution.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 illustrates an example of a configuration of an MFP according to an embodiment;

FIG. 2 is an explanatory view of a flow of image data in the MFP according to the embodiment; and

FIG. 3 is a flowchart of an operation example in the MFP according to the embodiment.

### DETAILED DESCRIPTION OF THE PREFERRED EMBODIMENTS

An exemplary embodiment of an image processing apparatus and an image processing method according to the present invention will be explained in detail below with reference to the accompanying drawings. While a case where an image processing apparatus according to the present invention is applied to an MFP (Multifunction Peripheral) at least including a scanner function and a printing function is taken as an example below, the present invention is not limited thereto.

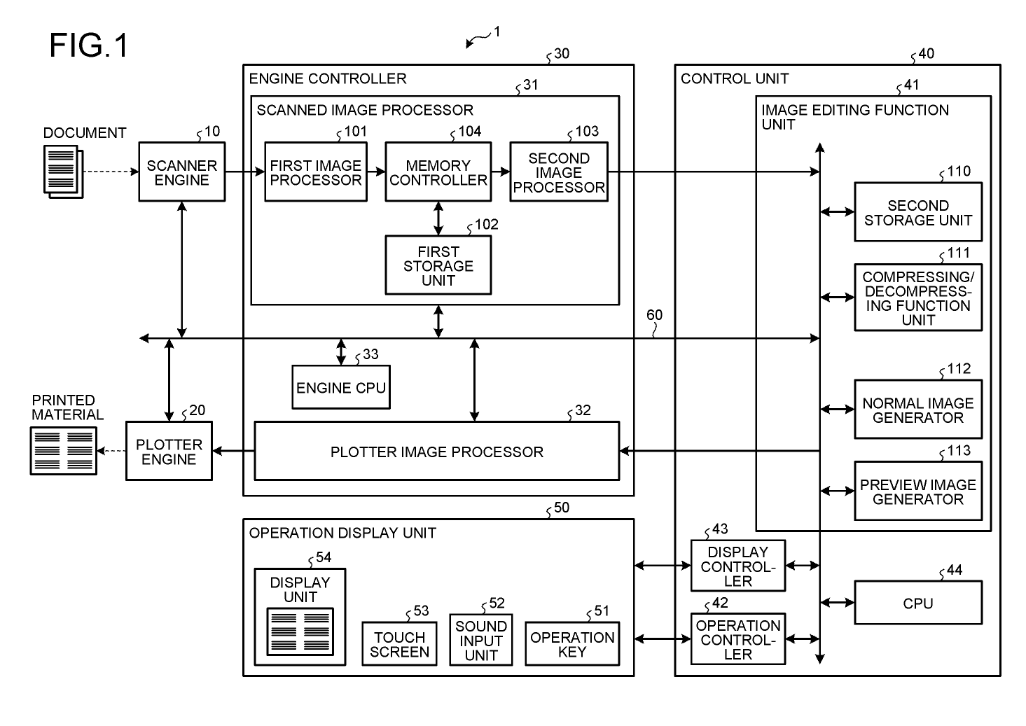

FIG. 1 illustrates an example of a configuration of an MFP 1 according to an embodiment. As illustrated in FIG. 1, the MFP 1 is provided with a scanner engine 10, a plotter engine 20, an engine controller 30, a control unit 40, and an operation display unit 50.

The scanner engine 10 has a function of scanning a document to obtain image data. More specifically, the scanner engine 10 includes an optical system for forming an image from a reflection light from the document and converts the image formed in the optical system into an electrical signal to generate image data. The scanner engine 10 may be referred to as a reader. The scanner engine 10, whose configuration is the same as that of a known scanner device and whose detailed illustration is omitted here, includes a light source that illuminates (exposes to light) a document, a lens unit (optical system) that focuses the reflection light from the document on a light reception area to form an image, and an imaging element that is provided for each light reception area and performs a photoelectric conversion of a light reception amount of each pixel to generate an electric signal. The scanner engine 10 supplies a first image processor 101 that will be explained later with the image data obtained by scanning the document.

The plotter engine 20 has a function of printing out (forming an image on a recording medium such as paper) based on the image data transmitted via a plotter image processor 32 of the engine controller 30 which will be explained later.

The engine controller 30 controls the operations of the scanner engine 10 and the plotter engine 20 under the control of the control unit 40. As illustrated in FIG. 1, the engine controller 30 is provided with a scanned image processor 31, the plotter image processor 32, and an engine CPU 33.

The scanned image processor 31 has a function of processing the image data input from the scanner engine 10 and transferring the processed image data to the control unit 40. In the example in FIG. 1, the scanned image processor 31 is provided with the first image processor 101, a first storage unit 102, a second image processor 103, and a memory controller 104.

The first image processor 101 performs a first image processing, in which settings by a user are not used, on the image data obtained by scanning the document (image data input from the scanner engine 10 in this example). In the first image processing in the embodiment, an image deterioration attributed to the optical system of the scanner engine 10 is corrected. More specifically, a distortion or unevenness (non-uniformity) in density in an image attributed to the optical system of the scanner engine 10 is corrected in the first image processing.

The first storage unit 102 stores first image data that corresponds to image data on which the first image processing is performed.

The second image processor 103 performs a second image processing, in which the settings by the user are used, on the first image data. The settings by the user, which are set for obtaining a target printed material, may include at least one of a setting for density, a setting for scaling, and a setting for shifting margin, for example. In this example, the user is able to input settings for obtaining a target printed material by operating an operation key 51 or a touch screen 53 of the operation display unit 50, which will be explained later. When the setting by the user (settings for obtaining the target printed material) are received in the operation display unit 50, the second image processor 103 is capable of performing the second image processing using the user settings on the first image data read out from the first storage unit 102. Besides, the user is also able to input the settings by a sound via a sound input unit (a microphone, for example) 52 of the operation display unit 50, for example.

The memory controller 104 controls the first storage unit 102. More specifically, the memory controller 104 is capable of controlling writing of the first image data to the first storage unit 102 and reading out of the first image data from the first storage unit 102. That is what the configuration of the scanned image processor 31 is like.

The plotter image processor 32 converts image data for printing transmitted from a normal image generator 112 of the control unit 40 to be explained later into image data suitable for characteristics of the plotter engine 20 and transfers the converted image data to the plotter engine 20.

The engine CPU 33 generally controls the operation of the engine controller 30. For example, the functions of the components (the first image processor 101, the second image processor 103, the memory controller 104, and the plotter image processor 32) of the engine controller 30 may be realized when the engine CPU 33 executes a program. The present invention is not limited thereto and at least a part of the functions of the components of the engine controller 30 may be realized by a dedicated hardware circuit (semiconductor integrated circuit and the like), for example.

Next, the control unit 40 will be explained. The control unit 40 generally controls the operation of the MFP 1. The control unit 40 and the engine controller 30 are connected to each other via a bus 60. As illustrated in FIG. 1, the control unit 40 is provided with an image editing function unit 41, an operation controller 42, a display controller 43, and a CPU 44.

The image editing function unit 41 generates a preview image which is a predicted image as a result of an execution of printing and image data for printing from second image data which corresponds to the first image data on which the second image processing is performed. In the example in FIG. 1, the image editing function unit 41 is provided with a second storage unit 110, a compressing/decompressing function unit 111, the normal image generator 112, and a preview image generator 113.

The second storage unit 110 stores the second image data. The compressing/decompressing function unit 111 performs a compression/decompression process on image data. The second storage unit 110 is also capable of storing the second image data after the compression/decompression process is performed thereon.

When an operation for starting to print is received by the operation display unit 50, the normal image generator 112 performs a processing including a rotation and an aggregation with respect to the image data (second image data) stored in the second storage unit 110 to generate image data for printing. The normal image generator 112 transfers the image data for printing to the plotter image processor 32.

The preview image generator 113 generates a preview image based on the second image data. More specifically, the preview image generator 113 reads out the second image data from the second storage unit 110 and converts the read second image data into a format suitable for a display unit 54 of the operation display unit 50. A preview image to be displayed in the display unit 54 is thus generated. The generated preview image is transferred to and displayed in the display unit 54 of the operation display unit 50 via the display controller 43, which will be explained later.

The operation controller 42 receives, from the operation display unit 50, information indicating the operation received by the operation display unit 50. The display controller 43 performs a control of displaying various kinds of images in the display unit 54 depending on the operation received by the operation display unit 50. The display controller 43 also performs a control of displaying the preview image generated by the preview image generator 113 in the display unit 54.

The CPU 44 generally controls the operation of the control unit 40. For example, the functions of the components (the compressing/decompressing function unit 111, the normal image generator 112, the preview image generator 113, the operation controller 42, and the display controller 43) of the control unit 40 may be realized when the CPU 44 executes a program. The present invention is not limited thereto and at least a part of the functions of the components of the control unit 40 may be realized by a dedicated hardware circuit (semiconductor integrated circuit and the like), for example.

Next, the operation display unit 50 will be explained. The operation display unit 50 receives an operation by the user and displays various kinds of images. As illustrated in FIG. 1, the operation display unit 50 is provided with the operation key 51, the sound input unit 52, the touch screen 53, and the display unit 54. The operation key 51, the sound input unit 52, and the touch screen 53 are used to input settings for obtaining a target printed material. The sound input unit 52 can be configured by a microphone, for example.

The display unit 54 displays various kinds of images. The display unit 54 can be configured by a liquid crystal display device, for example.

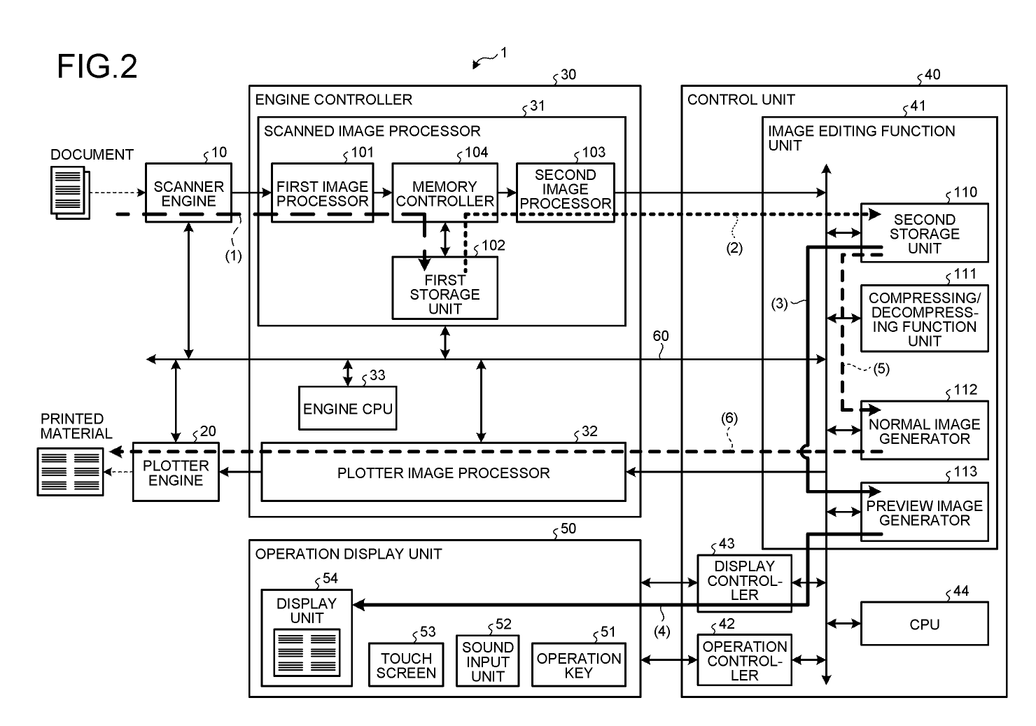

FIG. 2 is an explanatory view of a flow of image data in the MFP 1 according to the embodiment. As illustrated in (1) in FIG. 2, the image data obtained through scanning by the scanner engine 10 from the document is input to the first image processor 101 of the engine controller 30. The first image processor 101 performs the first image processing on the input image data to generate the first image data. The memory controller 104 performs a control of writing (storing) the first image data generated by the first image processor 101 in the first storage unit 102.

Since being for correcting deterioration, attributed to the optical system of the scanner engine 10, of an image, the first image processing is unsusceptible to the settings for the obtainment of a target printed material by a user. In other words, it is possible by using the first image data stored in the first storage unit 102 to obtain image data which follows the settings for the obtainment of a target printed material by a user.

As illustrated in (2) in FIG. 2, the first image data stored in the first storage unit 102 is transferred to the second image processor 103 via the memory controller 104. The second image processor 103 performs the second image processing using the settings for obtaining a target printed material (the settings for density, scaling, margin adjustment, and the like) on the input first image data to generate the second image data. The second image data generated by the second image processor 103 is stored in the second storage unit 110 of the control unit 40.

As illustrated in (3) in FIG. 2, the second image data stored in the second storage unit 110 is converted into a format suitable for the display unit 54 in the preview image generator 113. The preview image is thus generated.

As illustrated in (4) in FIG. 2, the preview image generated by the preview image generator 113 is transferred to and displayed in the display unit 54 via the display controller 43.

When the operation display unit 50 receives an operation for starting to print, the normal image generator 112 reads out the second image data from the second storage unit 110 and performs a processing including a rotation and an aggregation on the read second image data to generate image data for printing as illustrated in (5) in FIG. 2. The normal image generator 112 then transfers the image data for printing to the plotter image processor 32 of the engine controller 30.

As illustrated in (6) in FIG. 2, the plotter image processor 32 converts the image data for printing input from the control unit 40 into image data appropriate to the characteristics of the plotter engine 20 and transfers the converted image data to the plotter engine 20. The plotter engine 20 generates a printed material based on the image data input from the engine controller 30.

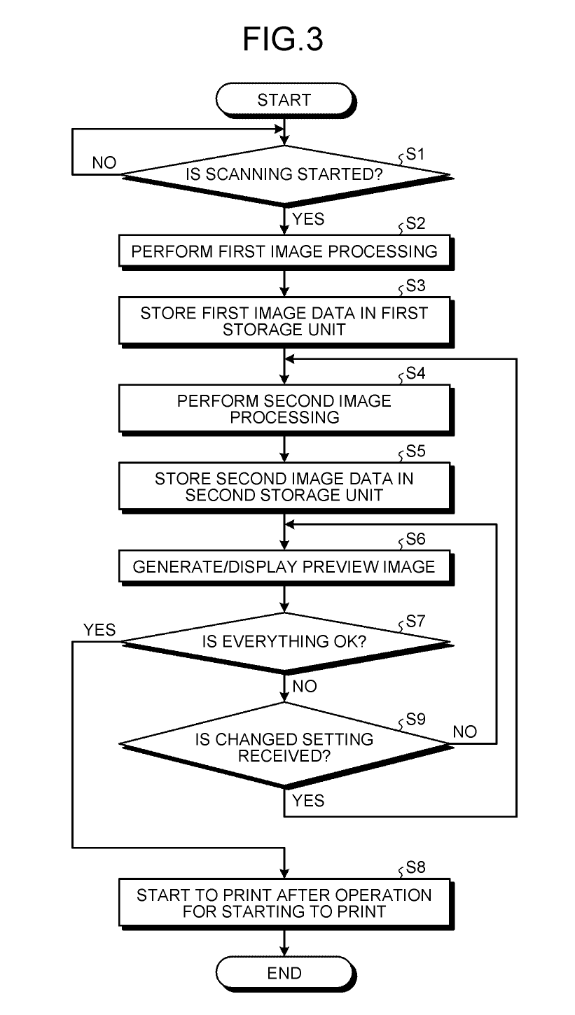

FIG. 3 is a flowchart of an operation example in the MFP 1 until printing is started after a preview image appropriate to the settings by the user is displayed. First, when document scanning is started (“Yes” at step S1) and image data obtained through the scanning by the scanner engine 10 is input to the first image processor 101, the first image processor 101 performs the first image processing on the input image data (the image data obtained by scanning the document) (step S2). The first image data is thus generated.

The memory controller 104 performs a control of storing the first image data generated by the first image processor 101 in the first storage unit 102 (step S3). Next, the memory controller 104 reads out the first image data stored in the first storage unit 102 and transfers the first image data to the second image processor 103, and the second image processor 103 performs the second image processing using the settings (default settings in this case) for obtaining a target printed material on the input first image data (step S4). The second image data is thus generated. The second image data generated at step S4 is stored in the second storage unit 110 (step S5).

Next, the preview image generator 113 generates a preview image based on the second image data stored in the second storage unit 110 and the display controller 43 performs a control of displaying the generated preview image in the display unit 54 (step S6). When an operation for inputting information indicating that everything is OK in the preview image (an operation of depressing a button “OK” displayed in the display unit 54, for example) is received from the user (“Yes” at step S7), printing is started after receiving an operation of instructing the start to print (step S8).

When the operation for inputting the information indicating that everything is OK in the preview image is not received (“No” at step S7) and settings changed by the user are received in the operation display unit 50 (“Yes” at step S9), the memory controller 104 reads out the first image data stored in the first storage unit 102 and transfers the first image data to the second image processor 103, and the second image processor 103 performs the second image processing using the changed settings on the input first image data (step S4). Specifically, when the settings are changed by the user, the second image processor 103 performs the second image processing using the settings changed by the user on the first image data read out from the first storage unit 102 to regenerate second image data.

When the operation for inputting information indicating that everything is OK in the preview image is not received (“No” at step S7) and the settings changed by the user are not received in the operation display unit 50 (“No” at step S9), the processing from step S6 is repeated.

As explained so far, the first image processing not using the settings (settings for obtaining a target printed material) by the user is performed on the image data obtained by scanning the document to generate and store in the first storage unit 102 the first image data, and the second image processing using the settings by the user is performed on the first image data stored in the first storage unit 102 to generate the second image data in the embodiment. The preview image is then generated based on the second image data, so that it is possible to generate the preview image following the settings by the user without the necessity of multiple scanning of the document.

Since, when the settings by the user are changed for example, the second image processing using the changed settings by the user is performed on the first image data stored in the first storage unit 102 to regenerate second image data and the preview image is generated based on the regenerated second image data, it is not necessary to rescan the document even though the settings by the user are changed.

While the embodiment according to the present invention is explained so far, the present invention is not limited directly to the embodiment and can be embodied by modifying the constituent elements without departing from the scope of the invention at a practical phase. Various inventions may be formed in an appropriate combination with the plurality of constituent elements disclosed in the embodiment. Some of all the constituent elements illustrated in the embodiment may be eliminated, for example.

While image data as an origin of the preview image is the second image data in the embodiment for example, the present invention is not limited thereto and the MRP 1 may further be provided with a selector that selects any one of the first image data and the second image data for the image data as the origin of the preview image, for example. The selector may select any one of the first image data and the second image data depending on the user operation, or may automatically select any one of the first image data and the second image data depending on the number of times when data is used as the image data as the origin of the preview image. The preview image generator 113 is then capable of generating a preview image based on the first image data or the second image data selected by the selector. When the first image data is selected by the selector, the preview image generator 113 converts the first image data read from the first storage unit 102 into a format suitable for the display unit 54 to generate the preview image.

The program to be executed in the MFP 1 according to the embodiment may be provided by being recorded in a file of an installable format or of an executable format in a computer-readable recording medium such as a CD-ROM, a flexible disk (FD), a CD-R, a DVD (Digital Versatile Disk), and a USB (Universal Serial Bus), or may be provided or distributed via a network such as the Internet. Moreover, programs of various kinds may be provided by being preloaded in a non-volatile recording medium such as a ROM.

According to the embodiment described above, it is possible to generate a preview image following user settings without a necessity of multiple scanning of a document.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An image processing apparatus comprising:
a first image processor configured to perform a first image processing not using a setting by a user on image data obtained by scanning a document;
a first storage unit configured to store first image data corresponding to the image data on which the first image processing has been performed;
a second image processor configured to perform a second image processing using the setting by the user on the first image data;
a second storage unit configured to store second image data corresponding to the first image data on which the second image processing has been performed; and
a preview image generator configured to generate a preview image based on the second image data, the preview image indicating a predicted result of a print execution.

2. The image processing apparatus according to claim 1, wherein the second image processor performs, when the setting by the user is changed, the second image processing using the changed setting by the user on the first image data read out from the first storage unit to regenerate the second image data.

3. The image processing apparatus according to claim 1, further comprising a reader including an optical system for forming an image from a reflection light from the document, the reader being configured to convert the image formed in the optical system into an electrical signal to generate the image data, wherein
the first image processing includes a process of correcting image attributed to the optical system.

4. The image processing apparatus according to claim 3, wherein the first image processing includes a process of correcting image distortion or density unevenness attributed to the optical system.

5. The image processing apparatus according to claim 1, wherein the setting by the user is set for obtaining a target printed material.

6. The image processing apparatus according to claim 5, wherein the setting by the user includes at least one of a setting for density, a setting for scaling, and a setting for margin adjustment.

7. The image processing apparatus according to claim 1, further comprising a display controller configured to control a display unit to display the preview image.

8. The image processing apparatus according to claim 1, further comprising a selector configured to select, as an origin of the preview image, any one of the first image data and the second image data, wherein
the preview image generator generates the preview image based on the one of the first image data and the second image data selected by the selector.

9. An image processing method comprising:
performing a first image processing not using a setting by a user on image data obtained by scanning a document;
performing a second image processing using the setting by the user on first image data stored in a first storage unit, the first image data corresponding to the image data on which the first image processing has been performed; and
generating a preview image based on second image data stored in a second storage unit, the second image data corresponding to the first image data on which the second image processing has been performed, the preview image indicating a predicted result of a print execution.
